(19) United States
(12) Patent Application Publication
(10) Pub. No.: US 2023/0115109 A1
(43) Pub. Date: Apr. 13, 2023

(54) FORK ARM SENSORS FOR DETECTING CROSS-TRAFFIC

(71) Applicant: ZF Friedrichshafen AG, Friedrichshafen (DE)

(72) Inventor: Gabriela Jager, Friedrichshafen (DE)

(73) Assignee: ZF Friedrichshafen AG, Friedrichshafen (DE)

(21) Appl. No.: 17/760,485

(22) PCT Filed: May 17, 2021
(86) PCT No.: PCT/EP2021/062947

§ 371 Date: Aug. 10, 2022

(30) Foreign Application Priority Data
Jun. 17, 2020 (DE) 10 2020 207 479.8

(51) Int. Cl. B66F 9/075; B66F 17/00

(52) U.S. Cl. CPC B66F 9/0755; B66F 17/003

(57) ABSTRACT

The invention relates to a forklift truck (101) with at least two environment sensors (105a, 105b) attached to different fork arms (103a, 103b). These are orientated with at least part of their detection zones (111a, 111b) directed outward and transversely to the forklift truck (101).

### RELATED APPLICATIONS

This application claims priority under 35 U.S.C. § 371 as a U.S. National Application of application no. PCT/EP2021/062947, filed on 17 May 2021, which claims priority to German Patent Application no. 10 2020 207 479.8, filed on 17 Jun. 2020, the contents of which are incorporated herein by reference in its entirety.

### FIELD OF THE DISCLOSURE

The invention relates to a forklift truck having fork arm sensors.

### BACKGROUND

The document EP 24 68 678 A1 discloses a forklift truck with fork arm sensors. These serve to control the uptake of loads. Correspondingly, the fork arm sensors are orientated to the front in the driving direction of the forklift truck.

From the document JP 2005 104 652 A1 another forklift truck is known, which has fork arm sensors for controlling the uptake of loads. The detection zones of these fork arm sensors are orientated transversely to the forklift truck, directed inward.

### SUMMARY

The purpose of the present invention is to increase the operating safety of a forklift truck. This objective is achieved by a forklift truck according to claim 1. Preferred further developments are described in the dependent claims and emerge from the following description and from the example embodiment illustrated in FIG. 1.

A forklift truck is a vehicle with a lifting fork. The lifting fork has a number of arms—usually just two—which serve to take up loads. The lifting fork can be moved to varying heights in order to take up the load and put it down again at the location required.

The forklift truck according to the invention has at least two environment sensors. These are sensors for detecting at least part of the environment of the forklift truck. The environment sensors are designed to scan that part of the environment of the forklift truck which lies within their detection zone. The environment sensors are preferably optical cameras, radar, lidar, or proximity sensors. These can form an environment sensor individually or in pairs. In the latter case the sensors are stereo-sensors or cameras consisting of two receiving units spaced apart by a distance.

The environment sensors are designed as fork arm sensors. This means that they are attached onto the fork arms. The invention also provides that the environment sensors are attached to different fork arms. In detail, in each case two environment sensors are not attached to the same fork arm. In particular, the forklift truck can have just two fork arms—one on the right and one on the left—and just two environment sensors—a left-hand environment sensor and a right-hand environment sensor. The right-hand environment sensor is attached to the fork arm on the right and the left-hand environment sensor to the form arm on the left. The terms “bottom right” and “bottom left” here refer to the driver's perspective, i.e. to the perspective of a forklift truck driver driving straight ahead.

According to the invention, the environment sensors are, in each case, orientated with at least part of the detection zone directed transversely outward at right angles to the forklift truck. Thus, the right-hand environment sensor is directed to the right and the left-hand environment sensor to the left. An orientation transverse to the forklift truck means the same as an orientation that is orthogonal to a longitudinal axis of the forklift truck. When driving straight ahead the longitudinal axis extends in the driving direction.

In detail, by virtue of the invention the detection zones of the fork arm sensors extend at least partially in the transverse direction, i.e. they are orientated perpendicularly to the longitudinal direction of the forklift truck. Thus, at least part of each detection zone of the fork arm sensors extends in the transverse direction. This means that at least one of the beams emerging in the transverse direction from each sensor is at least partially within the detection zone of that sensor. In particular, an initial part of the beam is within the detection zone. Preferably, the beam is completely within the detection zone.

Preferably, the environment sensors with their detection zones are orientated exactly transverse to the forklift truck. This means that a central axis or optical axis of each respective detection zone is orientated transversely to the forklift truck.

The detection zones of the environment sensors are in each case directed outward, at least in part. This means that starting from the sensor concerned, the said part extends outward relative to the forklift truck. Thus, the said at least part of the detection zone extends away from the forklift truck. Accordingly, in that part of the detection zone there is no fork arm. Preferably, the environment sensors are orientated in such manner that they do not detect any fork arm.

If there are just two environment sensors, their detection zones face away from one another. Preferably their orientations are mirror-symmetrical. The environment sensors with their detection zones are on opposite sides of a plane of symmetry, which preferably extends parallel to a longitudinal axis and a vertical axis of the forklift truck. The detection zones are in their entirety on opposite sides of the plane of symmetry. Thus, the detection zone of one environment sensor is completely on one side of the plane of symmetry whereas the detection zone of the other environment sensor is completely on the other side of the plane of symmetry.

Along with the fork arms, the environment sensors are also a distance apart from one another. An area between the environment sensors or between the fork arms is therefore not scanned by the environment sensors. In particular, this area can be delimited by a first plane that extends parallel to a longitudinal axis and a vertical axis of the forklift truck and by a second plane also parallel to a longitudinal axis and a vertical axis of the forklift truck. The said area extends between the first plane and the second plane. Preferably, the first plane and the second plane also intersect a respective environment sensor. The detection zones of the environment sensors extend completely on different sides of the first plane and on different sides of the second plane. A first detection zone of a first environment sensor is thus on a first side of the first plane and on a first side of the second plane, whereas a detection zone of a second environment sensor is on a second side of the first plane different from the first side thereof and on a second side of the second plane different from the first side thereof.

Preferably, moreover, at least part of the detection zones of the environment sensors are orientated horizontally. This means that the above-mentioned beams extend horizontally. In particular the central or optical axes of the environment sensors are directed horizontally in each case.

The invention makes it possible by virtue of the environment sensors to detect objects that are approaching the forklift truck. In that way hazardous collisions can be prevented. The invention is advantageous because the fork arm sensors are attached in exposed positions. Thus, the fork arms can detect cross-traffic which can perhaps not be detected from other positions on the forklift truck since the sightlines are blocked by obstacles. Typically, such situations occur in cross-over areas.

Preferably the forklift truck is further developed as part of an arrangement which, besides the forklift truck itself, comprises a data processing device. The data processing device is designed to recognize approaching objects by virtue of signals from the environment sensors. This implies that the environment sensors are connected with the data processing device for the purpose of transmitting signals.

The data processing device can be structurally integrated as a control unit in the forklift truck or it can be made as a separate unit. If it is a separate unit, the environment sensors are preferably connected with the data processing device by way of a wireless signal connection.

Signals from the environment sensors are evaluated by the data processing device and checked in relation to approaching objects. Preferably, a process implemented by the data processing device includes a part-step for detecting objects in the vicinity and a part-step for recognizing a movement of the said objects. Corresponding recognition processes are known from the prior art. For example, neuronal networks or stochastic methods can be suitable for recognizing objects and their movements.

The data processing device is preferably developed further to recognize the threat of a collision between an approaching object and the forklift truck. For this, the data processing device preferably assesses the movement of the approaching object and the movement of the forklift truck. With reference to the said movements, travel paths of the object and the forklift truck are extrapolated. Preferably, for that purpose a course of the travel path of the forklift truck and a course of the travel path of an approaching object are also taken into account.

### BRIEF DESCRIPTION OF THE DRAWINGS

A preferred example embodiment of the invention is illustrated in FIG. 1. Specifically, FIG. 1 shows:

FIG. 1: A forklift truck.

### DETAILED DESCRIPTION

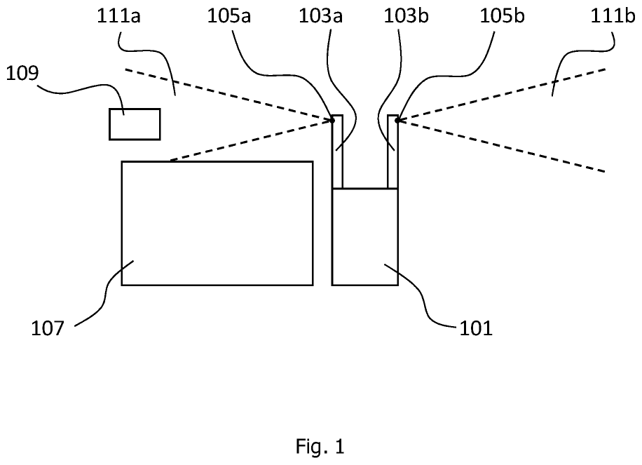

FIG. 1 shows a birds-eye view of the forklift truck 101. Its lifting fork comprises a left-hand arm 103a and a right-hand arm 103b. A left-hand fork arm sensor 105a is attached to the left-hand fork arm 103a and a right-hand fork arm sensor 105b is attached to the right-hand fork arm 103b.

Alongside the forklift truck 101 there is an obstacle 107. This blocks the view of the driver of the forklift truck 101, in relation to cross-traffic approaching the forklift truck from the left. Thus, an approaching object 109 is hidden by the obstacle 107.

A detection zone 111a of the left-hand fork arm sensor 105a extends to the left, starting from the left-hand fork arm sensor 105a and in the direction transverse to the forklift truck 101. Correspondingly, a detection zone 111b of the right-hand fork arm sensor 105b extends to the right, starting from the right-hand fork arm sensor 105b and in the direction transverse to the forklift truck 101. The two detection zones 111a, 111b are directed outward, away from one another. Thus, the object 109 is within the detection zone 111a of the left-hand fork arm sensor 105a.

A threatened collision of the object 109 and the forklift truck 101 can be recognized automatically by appropriate algorithms implemented in a control unit of the forklift truck 101. Alternatively, the signals from the fork arm sensors 105a, 105b can be visualized for a driver of the forklift truck, possibly in the form of a display. The driver could also be warned of a threatened collision by an acoustic signal.

### INDEXES

101 Forklift truck
103a Left-hand fork arm
103b Right-hand fork arm
105a Left-hand fork arm sensor
105b Right-hand fork arm sensor
107 Obstacle
109 Object
111a Detection zone
111b Detection zone

1. A forklift truck (101) having fork arms, the forklift truck comprising at least two environment sensors (105a, 106b) attached to different fork arms (103a, 103b), each of the at least two environment sensors (105a, 106b) having a detection zone, wherein the at least two environment sensors (105a, 105b) are orientated with at least part of the respective detection zone (111a, 111b) directed outward and transversely to the forklift truck (101).

2. The forklift truck (101) according to claim 1, further comprising a data processing device; wherein the data processing device is configured to recognize an approaching object (109) by virtue of one or more signals received from one or more of the at least two environment sensors (105a, 105b).

3. The forklift truck (101) according to claim 2, wherein the data processing device is configured, by virtue of the one or more signals received from the one or more of the at least two environment sensors (105a, 105b), to recognize a threatened collision between the approaching object (109) and the forklift truck (101).
